(19) United States
(12) Patent Application Publication
(10) Pub. No.: US 2010/0201694 A1
(43) Pub. Date: Aug. 12, 2010

(54) ELECTRONIC IMAGE DEVICE AND DRIVING METHOD THEREOF

(76) Inventors: Jae-Sung Lee, Yongin-city (KR); Chang-Hoon Lee, Yongin-City (KR)

Correspondence Address: LEE & MORSE, P.C., 3141 FAIRVIEW PARK DRIVE, SUITE 500, FALLS CHURCH, VA, 22042, US

(21) Appl. No.: 12/700,873

(22) Filed: Feb. 5, 2010

(30) Foreign Application Priority Data
Feb. 6, 2009 (KR) 10-2009-0009782

(51) Int. Cl. G06F 3/038; G06F 15/16

(52) U.S. Cl. 345/502; 345/213

(57) ABSTRACT

An electronic image device and driving method thereof allows a user to control a 3D image and eliminates a process for dividing an input image that is 3D image data into a left-eye image and a right-eye image. 3D image data signals may be generated directly from a 3D image signal or from a time divided 2D image signal.

### BACKGROUND OF THE INVENTION

1. Field

Embodiments relate to an electronic image device. More particularly, embodiments relate to an electronic image device for displaying 3D images and 2D images, and a driving method thereof.

2. Description of the Related Art

In general, whether a person can perceive a 3D effect depends on numerous factors, including a biological factor and an experimental factor. A 3D image display may express the 3D effect using binocular parallax, which is the greatest factor in recognizing the 3D effect at a short distance. An electronic image device for displaying the 3D image may use an optical element to divide a left image and a right image in a spatial manner and display the 3D image. Such optical elements may include, for example, a lenticular lens array or a parallax barrier.

The above information disclosed in this Background section is only for enhancement of understanding of the background of the invention and therefore it may contain information that does not form the prior art that is already known in this country to a person of ordinary skill in the art.

### SUMMARY

It is therefore a feature of an embodiment to provide an electronic image device and method thereof allowing a user to control displaying of 3D images regardless of input image data.

It is therefore another feature of an embodiment to provide an electronic image device and method thereof that omits a process for dividing 3D image data into a left-eye image and a right-eye image, and a driving method thereof.

At least one of the above and other features and advantages may be realized by providing an electronic image device, including a controller configured to generate an image data signal according to an input image signal of an input signal and a mode selector configured to control generation of the image data signal according to user selection and a pattern of the input signal. The controller includes a 3D graphics engine configured to generate, from the input image signal, a first time image corresponding to a first time and a second time image corresponding to a second time, different from the first time, and a 3D chip configured to receive the first and second time images or the input image signal and to generate a 3D image data signal. When the user selects a 3D image, the mode selector is configured to control the controller so that the input image signal is input to the 3D graphics engine when the input signal is 2D image data and the input image signal is input to the 3D chip when the input signal is 3D image data.

The controller may include a CPU configured to receive the input signal, generate the input image signal, and transmit the input image signal to one of the 3D graphics engine and the 3D chip by control by the mode selector.

The first time may be a left eye time and the second time may be a right eye time. The 3D image data signal may include a first 3D image data signal combined in the order of the first time image and the second time image and a second 3D image data signal combined in the order of the second time image and the first time image.

The electronic image device may include barrier including a first sub-barrier configured to display the first 3D image data signal and a second sub-barrier to display the second 3D image data signal. The 3D chip may be configured to output a barrier control signal to control the barrier.

The controller may be configured to generate image data signals at different frequencies in accordance with whether the user selects the 3D image or not. When the user selects the 3D image, the controller may be configured to output the image data signal at twice a frequency that the controller output the image data signal when the user does not select the 3D image.

When the user selects a 2D image and the input signal is 2D image data, the controller may be configured to output a 2D image data signal. The 3D chip may be configured to output a scan control signal and a data control signal.

At least one of the above and other features and advantages may be realized by providing a method for driving an electronic image device, including generating an input image signal for an input signal, and determining whether a user has selected displaying of a 3D image. When the user selects displaying of a 3D image and the input signal is 2D image data, the method includes generating a first time image corresponding to a first time and a second time image corresponding to a second time other than the first time from the input image signal, generating a 3D image data signal using the first time image and the second time image, and generating the 3D image data signal using the input image signal when the input signal is 3D image data.

Generating the 3D image data signal may include generating a first 3D image data signal combined in the order of the first time image and the second time image, and generating a second 3D image data signal combined in the order of the second time image and the first time image.

The method may include setting a first sub-barrier for displaying the first 3D image data signal to be non-transmitting and setting a second sub-barrier for displaying the second 3D image data signal to be non-transmitting. Generating the 3D image data signal may include outputting a barrier control signal to control the barrier.

The first time may be a left eye time and the second time may be a right eye time. Determining whether the user has selected a 3D signal may include analyzing a mode select signal.

Generating the image data signals may include generating the image data signals at different frequencies in accordance with whether the user selects the 3D image or not. When the user selects the 3D image, the image data signal may be generated at twice a frequency that the image data signal when the user does not select the 3D image.

When the user does not select a 3D image and the input signal is 2D image data, the image data signal may be a 2D image data signal. Generating the 3D image data signal may include outputting a scan control signal and a data control signal.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a block diagram of an electronic image device according to an exemplary embodiment of the present invention;

FIG. 2 illustrates an equivalent circuit of a pixel of a display device shown in

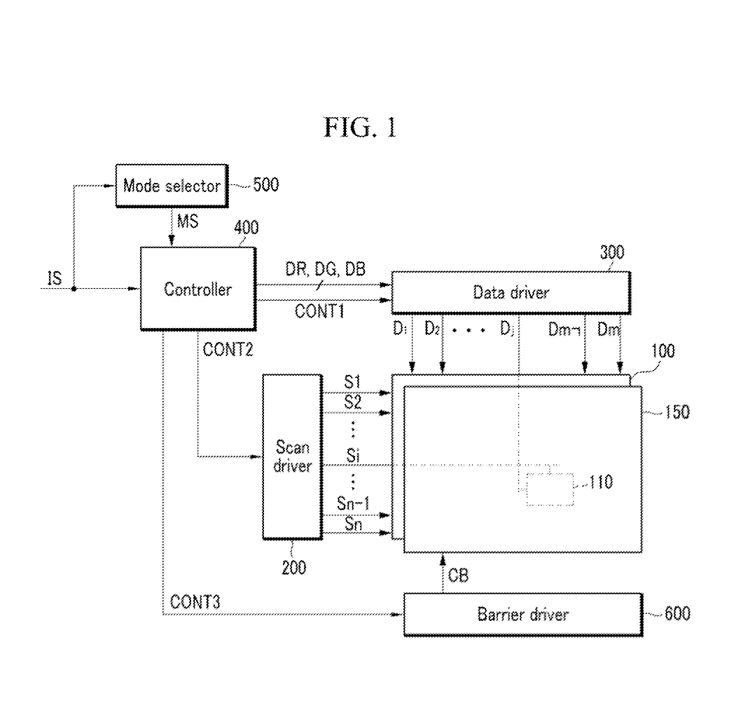

FIG. 1;

FIG. 3A and FIG. 3B illustrate a time-division driving method of a 2D/3D image display device according to an exemplary embodiment of the present invention; and

FIG. 4 illustrates a detailed block diagram of a controller shown in FIG. 1.

### DETAILED DESCRIPTION

Korean Patent Application No. 10-2009-0009782 filed on Feb. 6, 2009, in the Korean Intellectual Property Office, and entitled “Electronic Imaging Device and Method Thereof,” is incorporated by reference herein in its entirety.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

An electronic image device and a driving method thereof according to an exemplary embodiment of the present invention will now be described.

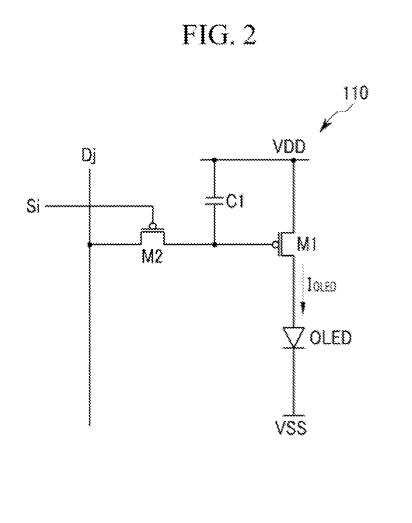

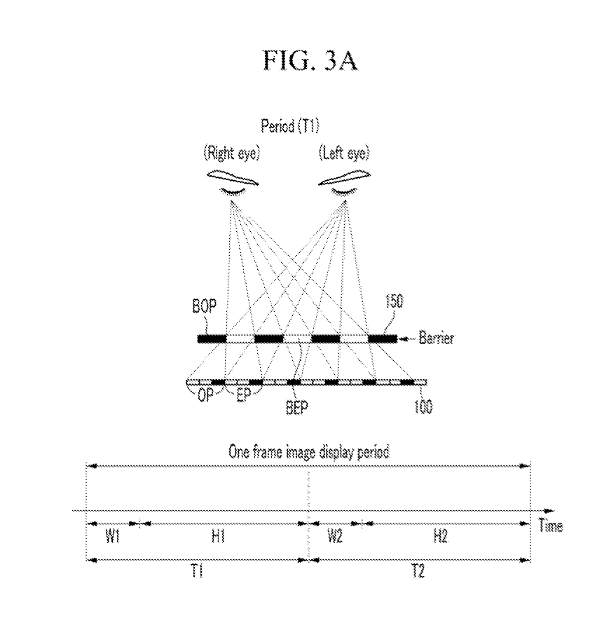

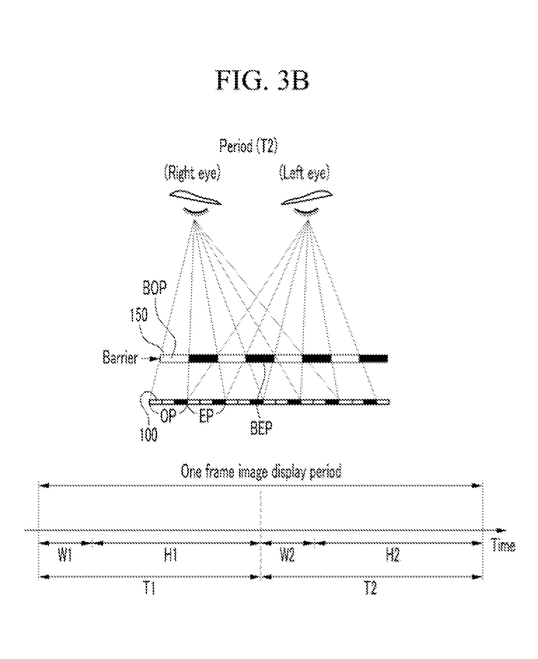

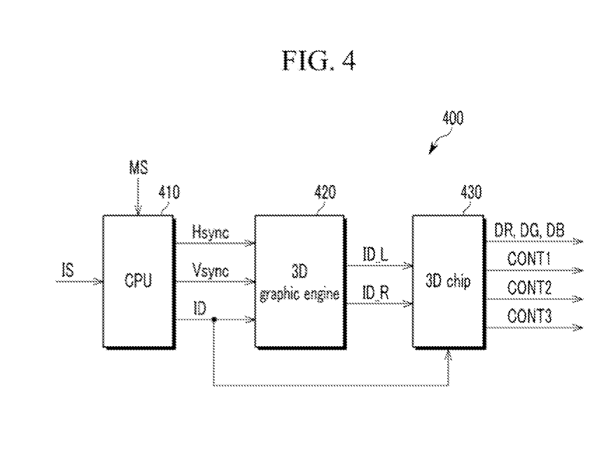

FIG. 1 illustrates a block diagram of an electronic image device according to an exemplary embodiment of the present invention. FIG. 2 illustrates an equivalent circuit of a pixel of a display device shown in FIG. 1.

Referring to FIG. 1, the electronic image device may include a display 100, a scan driver 200, a data driver 300, a controller 400, a mode selector 500, and a barrier driver 600.

The display 100 may include a plurality of signal lines S1-Sn and D1-Dm, a plurality of voltage lines (not shown), and a plurality of pixels 110 connected thereto and arranged as a matrix.

The signal lines S1-Sn and D1-Dm may include a plurality of scan lines S1-Sn for transmitting scan signals and a plurality of data lines D1-Dm for transmitting data signals. The scan lines S1-Sn may be substantially arranged in the row direction and parallel with each other. The data lines D1-Dm may be substantially arranged in the column direction and parallel with each other. The data signal may be a voltage signal (hereinafter, a data voltage) or a current signal (hereinafter, a data current) according to a type of pixel 110 used in the display 100. Hereinafter, the data signal will be exemplified as a data voltage.

Referring to FIG. 2, the pixel 110 connected to the i-th (i=1, 2, . . . , n) scan line Si and the j-th (j=1, 2, . . . , m) data line Dj may include an organic light emitting element, a driving transistor M1, a capacitor C1, and a switching transistor M2.

The switching transistor M2 may include a control terminal, an input terminal, and an output terminal. The control terminal may be connected to the scan line Si, the input terminal may be connected to the data line Dj, and the output terminal may be connected to the driving transistor M1. The switching transistor M2 may transmit a data signal applied to the data line Dj, i.e., a data voltage, in response to a scan signal applied to the scan line Si.

The driving transistor M1 may also include a control terminal, an input terminal, and an output terminal. The control terminal may be connected to a switching transistor M2, the input terminal may be connected to a driving voltage Vdd, and the output terminal may be connected to the organic light emitting element. The driving transistor M1 may output a current (IOLED) that varies in accordance with the voltage between the control terminal and the output terminal.

The capacitor C1 may be connected between the control terminal and the input terminal of the driving transistor M1. The capacitor C1 may store the data voltage applied to the control terminal of the driving transistor M1 and may maintain the same when the switching transistor M2 is turned off.

The organic light emitting element may be an organic light emitting diode (OLED) having an anode connected to an output terminal of the driving transistor M1 and a cathode connected to a common voltage Vss. The OLED may display the image by varying intensity and emitting light according to the output current (IOLED) of the driving transistor M1.

The OLED may emit one of three primary colors, e.g., red, green, and blue. A desired color may be displayed by a spatial or temporal sum of the three primary colors. In this case, some OLEDs may emit white light to thereby increase the luminance. Alternatively, all OLEDs of the pixels 110 may emit white light and a predetermined number of pixels 110 may further include a color filter (not shown) for changing the white light output by an OLED into one of the primary colors.

The switching transistor M2 and the driving transistor M1 are illustrated as p-channel field effect transistors (FETs). In this case, the control terminal, the input terminal, and the output terminals correspond to a gate, a source, and a drain, respectively. However, at least one of the switching transistor M2 and the driving transistor M1 may be an n-channel FET. Also, the connection states of the transistors M1 and M2, the capacitor C1, and the OLED may be changed.

The pixel 110 shown in FIG. 2 is an example of the pixel of the display device, other pixel configurations, e.g., including at least two transistors or at least one capacitor, may be used. Further, a pixel may receive a data current, rather than the data voltage, as a data signal.

Referring to FIG. 1, the scan driver 200 may be connected to the scan lines S1-Sn of the display 100 and may sequentially apply a scan signal to the scan lines S1-Sn according to a data control signal CONT2. The scan signal may be generated by a combination of a gate on voltage Von for turning on the switching transistor M2 and a gate off voltage Voff for turning off the switching transistor M2. When the switching transistor M2 is a p-channel FET, the gate on voltage Von and the gate off voltage Voff are a low voltage and a high voltage, respectively.

The data driver 300 may be connected to the data lines D1-Dm of the display 100, may convert the data signals DR, DG, and DB input by the controller 400 into a data voltage according to a scan control signal CONT1, and may apply the same to the data lines D1-Dm.

The controller 400 may receive an external input signal IS to generate image data signals DR, DG, and DB, the scan control signal CONT1, the data control signal CONT2, and a barrier drive control signal CONT3. Here, the input signal IS may be one of 2D image data and 3D image data including respective point-of-view image data. When the 2D image and the 3D image are to be displayed on the display 100, the input signal IS may include both the 2D image data and the 3D image data. The image data signals DR, DU, and DB may include an image data signal (hereinafter, a 3D image data signal) for the 3D image and an image data signal (hereinafter, 2D image data signal) for the 2D image. The controller 400 may generate an image data signal according to the input signal IS and the mode selection signal MS, which will be described later.

The mode selector 500 may control the controller 400 according to the image format desired by the user. The mode selector 500 may be included in a user menu of the electronic image device or may be realized as another switch to be turned on/off by the user. Selection of the 3D image by the user may allow the display to provide the 3D image to the user irrespective of the input signal IS.

In detail, the mode selector 500 may determine whether the input signal IS includes 3D image data when the user selects a 3D image. When the input signal IS includes 2D image data, but not 3D image data, the mode selector 500 may control the controller 400 to generate a 3D image data signal. When the image pattern selected by the user and the pattern of the input signal IS are the same, the mode selector 500 may transmit no instruction to the controller 400. The mode selector 500 may transmit an instruction by transmitting a mode selection signal MS to the controller 400. In detail, the mode selection signal MS may have two levels, e.g., a high level that controls the controller 400 to generate a 3D image data signal from the 2D image data and a low level that allows the controller 400 to generate the image data signal in accordance with the input signal IS.

The barrier driver 600 may drive the barrier layer 150 according to the barrier driver control signal CONT3. The electronic image device according to the exemplary embodiment of the present invention may adopt the time-division drive method for displaying the 3D image.

The barrier driver 600 may be operated by the time-division drive method. A time-division drive method according to an exemplary embodiment of the present invention will now be descried with reference to FIGS. 3A and 3B.

FIG. 3A and FIG. 3B illustrate a time-division driving method of a 2D/3D image display device according to an exemplary embodiment of the present invention.

The time-division drive method may include a first method for alternately operating the right and the left of the light source, and identifying the right and the left with time-division using an optical element combined with a prism and a lenticular lens, and a second method for dividing one section of the slit through which the light is transmitted in a liquid crystal barrier into a plurality of units, synchronizing them with the displayed image, and thereby moving the slit. The electronic image device according to the exemplary embodiment of the present invention will be described based on the second method. However, the present invention is not restricted thereto, and when the first method is used, an optical element with the combination of a light source, a prism, and a lenticular lens other than the liquid crystal barrier may be used. Further, FIG. 3A and FIG. 3B are described based on two eyes, and the case of multiple eyes is also operable by the same principle.

First, FIG. 3A illustrates a case in which an image combined in the order of the left-eye image and the right-eye image (hereinafter, a left-right image) during the first period T1 when a frame is divided into two periods T1 and T2 to be time-division driven. FIG. 3B illustrates a case in which an image is combined in the order of the right-eye image and the left-eye image (hereinafter, a right-left image) during the second period T2. The periods T1 and T2 may be divided into data writing periods W1 and W2 and sustain periods H1 and H2, respectively. When a new image is displayed and writing of the image on the screen is finished during the writing period, the screen is maintained during the sustain period.

In FIG. 3A, in the period T1, an odd pixel OP of the display 100 represents the left-eye pixel and an even pixel EP represents the right-eye pixel. In this instance, the odd pixel BOP of the barrier layer 150 may be non-transparent and the even pixel BEP may be transparent. Then, as shown in FIG. 3A, a path in which the left-eye image is transmitted to the left eye and the right-eye image is transmitted to the right eye is formed. The left-eye image transmitted from the odd pixel OP is formed to be an image with predetermined disparity with respect to the right-eye image and the right-eye image transmitted from the even pixel EP is formed to be an image with predetermined disparity with respect to the left-eye image. Therefore, the user acquires depth information with respect to the left and right eyes to perceive the 3D effect when viewing the left-eye image transmitted from the odd pixel OP and the right-eye image transmitted from the even pixel EP.

In FIG. 3B, in the period T2, the odd pixel OP of the display 100 represents the right-eye pixel and the even pixel EP represents the left-eye pixel. In this instance, the odd pixel BOP of the barrier layer 150 may be transparent and the even pixel BEP may be a non-transparent. Then, as shown in FIG. 3B, a path in which the left-eye image is transmitted to the left eye and the right-eye image is transmitted to the right eye is formed. The right-eye image transmitted from the odd pixel OP is formed to be an image with predetermined disparity with respect to the left-eye image, and the left-eye image transmitted from the even pixel EP is formed to be an image with predetermined disparity with respect to the right-eye image. Therefore, the user acquires depth information through the left and right eyes to perceive the 3D effect when viewing the right-eye image transmitted from the odd pixel OP and the left-eye image transmitted from the even pixel EP.

Accordingly, the odd pixel may be expressed as the left eye and the even pixel may be expressed as the right eye in the period T1, and the odd pixel may be expressed as the right eye and the even pixel may be expressed as the left eye. Hence, the user may view the 3D image with the same resolution as the 2D image.

FIG. 4 illustrates a detailed block diagram of the controller 400 shown in FIG. 1, and a configuration for generating the 3D image data will be described with reference to FIG. 4. Referring to FIG. 4, the controller 400 may include a CPU 410, a 3D graphics engine 420, and a 3D chip 430.

The CPU 410 may receive the input signal IS to generate an input image signal ID, a horizontal synchronization signal Hsync, and a vertical synchronization signal Vsync, and may transmit the input image signal ID to one of the 3D graphics engine 420 and the 3D chip 430 according to the input signal IS and the mode selection signal MS, which will be described later.

The 3D graphics engine 420 may receive the input image signal ID and may generate a left eye image signal ID_L and a right eye image signal ID_R in response thereto. The 3D chip 430 may receive one of the left eye and right eye image signals ID_L and ID_R and the input image signal ID to generate image data signals DR, DG, and DB, the scan control signal CONT1, the data control signal CONT2, and the barrier drive control signal CONT3. Here, the 3D chip 430 may determine frequencies of the image data signals DR, DG, and DB, the scan control signal CONT1, the data control signal CONT2, and the barrier drive control signal CONT3 depending on displaying of one of the 3D image and the 2D image to the display 100. In detail, when the 2D image is displayed, the 3D chip may generate the image data signals DR, DG, and DB, the scan control signal CONT1, the data control signal CONT2, and the barrier drive control signal CONT3 at a frequency of 60 Hz, and, when the 3D image is displayed, the 3D chip may generate the same at a frequency of 120 Hz.

The scan control signal CONT1 may include a scan start signal for instructing scan start and a first clock signal. In this instance, the scan start signal according to the exemplary embodiment of the present invention may be synchronized with the vertical synchronization signal Vsync for instructing the start of transmitting one-frame image data to control the time for starting to display the one-frame image to the display, and the first clock signal may be synchronized with the horizontal synchronization signal Hsync for instructing to transmit the input image data for the pixels of one row to control the time for transmitting a selection signal to the scan lines S1-Sn. The data control signal CONT2 may include a second clock signal synchronized with the horizontal synchronization signal Hsync and having a predetermined period, and a horizontal synchronization start signal for controlling the start of transmitting the data signal. The barrier drive control signal CONT3 may control the barrier layer 150.

A method for driving the above-configured electronic image device according to an embodiment of the present invention will now be described.

First, when the mode selection signal MS has a high level and the input signal IS is 2D image data, the CPU 410 may transmit the input image signal ID to the 3D graphics engine 420. The 3D graphics engine 420 may generate left eye and right-eye image signals ID_L and ID_R, and may transmit these signals to the 3D chip 430. The 3D chip 430 may combine the left eye and right-eye image signals ID_L and ID_R to generate a 3D image data signal satisfying the time-division drive method. When the input signal IS is 3D image data, the CPU 410 may transmit the input image signal ID to the 3D chip 430. When the input image signal ID includes the left eye and right eye image data as 3D image data, the 3D chip 430 may combine the data to generate a 3D image data signal satisfying the time-division drive method.

When the mode selection signal MS has a low level and the input signal IS is 3D image data, the CPU 410 may transmit the input image signal ID to the 3D chip 430 to generate a 3D image data signal. When the input signal IS is 2D image data, the controller 400 may generate a 2D image data signal.

Accordingly, the electronic image device according to the exemplary embodiment of the present invention and the driving method thereof allow the user to control displaying of the 3D images, and may omit the process for dividing the input image that is 3D image data into the left-eye image and the right-eye image.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An electronic image device, comprising:
a controller configured to generate an image data signal according to an input image signal of an input signal; and
a mode selector configured to control generation of the image data signal according to user selection and a pattern of the input signal,
wherein the controller includes:
a 3D graphics engine configured to generate, from the input image signal, a first time image corresponding to a first time and a second time image corresponding to a second time, different from the first time; and
a 3D chip configured to receive the first and second time images or the input image signal and to generate a 3D image data signal, and
when the user selects a 3D image, the mode selector is configured to control the controller so that the input image signal is input to the 3D graphics engine when the input signal is 2D image data and the input image signal is input to the 3D chip when the input signal is 3D image data.

2. The electronic image device as claimed in claim 1, wherein the controller further includes a CPU configured to receive the input signal, generate the input image signal, and transmit the input image signal to one of the 3D graphics engine and the 3D chip by control by the mode selector.

3. The electronic image device as claimed in claim 1, wherein the first time is a left eye time and the second time is a right eye time.

4. The electronic image device as claimed in claim 1, wherein
the 3D image data signal includes a first 3D image data signal combined in the order of the first time image and the second time image and a second 3D image data signal combined in the order of the second time image and the first time image.

5. The electronic image device as claimed in claim 1, further comprising a barrier including a first sub-barrier configured to display the first 3D image data signal and a second sub-barrier to display the second 3D image data signal.

6. The electronic image device as claimed in claim 5, wherein the 3D chip is configured to output a barrier control signal to control the barrier.

7. The electronic image device as claimed in claim 1, wherein the controller is configured to generate image data signals at different frequencies in accordance with whether the user selects the 3D image or not.

8. The electronic image device as claimed in claim 7, wherein, when the user selects the 3D image, the controller is configured to output the image data signal at twice a frequency that the controller output the image data signal when the user does not select the 3D image.

9. The electronic image device as claimed in claim 1, wherein, when the user selects a 2D image and the input signal is 2D image data, the controller is configured to output a 2D image data signal.

10. The electronic image device as claimed in claim 1, wherein the 3D chip is configured to output a scan control signal and a data control signal.

11. A method for driving an electronic image device, comprising:
generating an input image signal for an input signal;
determining whether a user has selected displaying of a 3D image;
when the user selects displaying of a 3D image and the input signal is 2D image data, generating a first time image corresponding to a first time and a second time image corresponding to a second time other than the first time from the input image signal;
generating a 3D image data signal using the first time image and the second time image; and
generating the 3D image data signal using the input image signal when the input signal is 3D image data.

12. The method as claimed in claim 11, wherein generating the 3D image data signal includes:
generating a first 3D image data signal combined in the order of the first time image and the second time image; and
generating a second 3D image data signal combined in the order of the second time image and the first time image.

13. The method as claimed in claim 11, further comprising:
setting a first sub-barrier for displaying the first 3D image data signal to be non-transmitting; and
setting a second sub-barrier for displaying the second 3D image data signal to be non-transmitting.

14. The method as claimed in claim 13, wherein generating the 3D image data signal includes outputting a barrier control signal to control the barrier.

15. The method as claimed in claim 11, wherein the first time is a left eye time, and the second time is a right eye time.

16. The method as claimed in claim 11, wherein determining whether the user has selected a 3D signal includes analyzing a mode select signal.

17. The method as claimed in claim 11, wherein generating the image data signals includes generating the image data signals at different frequencies in accordance with whether the user selects the 3D image or not.

18. The method as claimed in claim 17, wherein, when the user selects the 3D image, the image data signal is generated at twice a frequency that the image data signal when the user does not select the 3D image.

19. The method as claimed in claim 11, when the user does not select a 3D image and the input signal is 2D image data, the image data signal is a 2D image data signal.

20. The method as claimed in claim 11, wherein generating the 3D image data signal includes outputting a scan control signal and a data control signal.
